(19) United States
(12) Patent Application Publication
(10) Pub. No.: US 2022/0188365 A1
(43) Pub. Date: Jun. 16, 2022

(54) DISTRIBUTED IN-MEMORY SPATIAL DATA STORE FOR K-NEAREST NEIGHBOUR SEARCH

(71) Applicant: GRABTAXI HOLDINGS PTE. LTD., Singapore (SG)

(72) Inventors: Zhiyin ZHANG, Beijing (CN); Xiaocheng HUANG, Singapore (SG); Chaotang SUN, Beijing (CN); Shaolin ZHENG, Beijing (CN)

(21) Appl. No.: 17/602,961

(22) PCT Filed: Apr. 12, 2019
(86) PCT No.: PCT/CN2019/082349

§ 371 Date: Oct. 11, 2021

(51) Int. Cl. G06F 16/903

(52) U.S. Cl. CPC G06F 16/90335

(57) ABSTRACT

A database system is configured to enable fast searching for neighbours nearest to a mobile object located in a geographical space made up of plural spatially distinct subspaces, each being made up of plural cells. The database system has an operating system controlling storage of object data amongst the plural storage nodes, to represent one or more spatially distinct subspaces, in a respective single one of the storage nodes. Location data of each object is used to index that object with respect to cells making up each spatially distinct subspace in each node.

### FIELD OF THE INVENTION

The invention relates in general to data storage and retrieval. More particularly but not exclusively the invention relates to database systems for facilitating K-nearest neighbour searching. An exemplary embodiment is in the field of managing a ride-hailing service.

### BACKGROUND

In a typical ride hailing scenario, a potential user places a booking request through the smart phone app, which is then fulfilled by the host by dispatching the most suitable, nearby service provider available to provide the required service.

Locating nearest moving objects (e.g. drivers) in real-time is one of the fundamental problems that a ride-hailing service needs to address. A host tracks service providers' real-time geographical positions and searches for K available service providers near a user's location for each booking request because the closest service provider may not always be the best choice. To simplify the problem, straight line distance may be used rather than routing distance.

Unlike existing research on K-nearest neighbour (kNN) queries over static objects such as locating the K nearest restaurants, or continuous K-nearest neighbour queries over moving objects, such as finding the K nearest gas stations to a moving car, an issue involves moving objects that execute dynamic K-nearest queries, which poses challenges.

### PRIOR ART

K-nearest neighbour search on static objects, such as locating nearest restaurants, focuses on indexing objects properly. There are two main indexing approaches: object-based and solution-based.

Object-based indexing targets the locations of objects. An R-tree uses minimum bounding rectangles to build a hierarchical index where K-nearest neighbours can be computed by spatial joins. The solution-based approach focuses on indexing a pre-computed solution space, for example dividing the solution space based on a Voronoi diagram and pre-computes the result of any nearest-neighbour search corresponding to a Voronoi cell. Other approaches combine the former two approaches and proposes a grid-partition index that stores objects that are potential nearest neighbours of any query falling within the Voronoi cells.

To accelerate kNN queries on static objects based on an index, it has been proposed to develop a branch-and-bound algorithm based on an R-tree to do a best first search while maintaining a priority list of K-nearest objects.

Another approach studies moving-kNN queries over static objects, where it returns more than K result items so that the K-nearest query at a new location will also be contained in the previous result.

However, maintaining such complex indices on moving objects suffers from frequent location updates.

Indexing moving/mobile objects can be classified into two categories: (1) indexing of the current and anticipated future positions of moving objects, and (2) indexing of trajectories.

One earlier work focuses on the indexing of the current and anticipated future positions of moving objects and proposes a time-parameterized R-tree (i.e., TPR-tree) index. The bounding rectangles in the TPR-tree are functions of time and continuously follow the enclosed data points or other rectangles as they move.

Indexing trajectory approaches propose Trajectory-Bundle tree (TB-tree) that preserves historical trajectories and allows for R-tree-typical range searches. Note though that in our setting, objects' past trajectories are of no interest.

Continuous K-nearest neighbour search over static objects has also attracted attention, for instance to find the three nearest gas stations of a moving car on any point along a pre-specified path.

In contrast to traditional approaches where objects are indexed, another approach builds indexes on both queries (i.e., Q-index) and objects (i.e., Velocity Constrained Indexing (VCI)). Yet another approach assumes objects are moving constantly at a current velocity and thus is able to infer K-nearest objects at a future timestamp. More works on continuous query monitoring all pay attention to indexing queries. However, these methods either make assumptions on how the query moves (for example, along a trajectory) or assume an in-memory global index.

It should be noted that it is not trivial to scale the aforementioned complex index techniques in the presence of a high volume of write operations. A simple index structure which scales easily for both read and write operations is well suited for real-life applications.

Moving object databases are very challenging. One approach considers databases that track and update moving objects' locations. Though the focus is to decide when the location of a moving object in the database should be updated. Spatial databases manage spatial data and support GIS (Geographic Information Systems) queries such as whether a query point is contained in a polygon area.

A technical problem is that databases are not suitable for handling heavy write loads because of huge I/O costs.

Scalable in-memory key-value data stores scale well under frequent writes. In a key-value data store, objects are keys while their locations are values. Answering a K-nearest search therefore requires scanning all the keys, the latency of which is not acceptable.

### SUMMARY OF THE INVENTION

In a first aspect, there is disclosed a scalable in-memory spatial data store tailored for kNN searches, in which data storage is decentralised.

In a second aspect, there is disclosed a system and a method for locating nearest moving objects (drivers) in real-time.

In a third aspect, there is disclosed a database system configured to enable fast searching for neighbours nearest to a moving object located in a geographical space made up of plural spatially distinct spatial shards, each being made up of plural cells, being configured to control store object data amongst plural storage nodes, whereby the data are stored in a decentralised fashion, with location data of each moving object used to index that object with respect to cells making up each spatially distinct shard in each node

In a fourth aspect, there is disclosed a database system configured to enable fast searching for neighbours nearest to an object located in a geographical space made up of plural spatially distinct subspaces, each being made up of plural cells, the database system comprising plural storage nodes; and an operating system, the operating system being configured to control storage of object data amongst the plural nodes, wherein the operating system is configured to cause storage of data representative of one or more spatially distinct subspaces in a respective single one of the storage nodes, and wherein location data of each object is used to index that object with respect to cells making up each spatially distinct subspace in each node.

In another aspect, there is disclosed a method of storing data to enable fast searching for neighbours nearest to an object located in a geographical space made up of plural spatially distinct subspaces, each being made up of plural cells, the database system comprising plural storage nodes; the method comprising storing object data amongst the plural storage nodes, such that data representative of one or more spatially distinct subspaces is stored in a respective single one of the storage nodes, and using location data of each object to index that object with respect to cells making up each spatially distinct subspace in each storage node.

In yet another aspect, there is disclosed a method of accelerating a nearest-neighbour search comprising distributing data in plural storage nodes according to the geographical relationship between the data, thereby allowing a search of data to be performed using a reduced number of remote calls.

In a further aspect, there is disclosed a scalable in-memory spatial data store for kNN searches comprising a database system as claimed in the fourth aspect

In an embodiment, the data of each spatially distinct subspace is stored completely in a single storage node.

In embodiments, data of each spatially distinct subspace is replicated to plural storage nodes to form data replicas.

In embodiments, write operations concerning a spatially distinct subspace are propagated to all the relevant data replicas. A quorum-based voting protocol may be used.

The number of replicas, in some embodiments, is configurable based on use cases.

In some embodiments, a breadth-first search algorithm answers K-nearest neighbour queries

In one family of embodiments, data are stored in the plural storage nodes using consistent hashing thereby assigning to an abstract hash circle.

In another family of embodiments, data are stored in the plural storage nodes using a user-configurable mapping from subspaces to storage nodes which explicitly defines which subspace belongs to which storage node.

In yet another family, both a user-configurable mapping from subspaces to storage nodes which explicitly defines which subspace belongs to which node, and consistent hashing are used for different data.

Data in the database is, in a set of embodiments, stored in-memory.

For data not included in the mapping, consistent hashing may be employed.

One node in the mapping may be used as a static coordinator to broadcast new joins.

Gossip style messaging may be used to allow node discovery.

The objects may be moving or at least mobile and may be service provider vehicles of a ride-hailing system.

Such a database system may be configured to address the problem of volume of write operations by distributing data to different nodes and storing in-memory.

In another aspect, there is provided a database system in which an operating system distributes data in plural storage nodes according to the geographical relationship between the data, thereby allowing a search of data to be performed using a reduced number of remote calls.

### BRIEF DESCRIPTION OF THE DRAWINGS

This patent or application file contains at least one drawing executed in color. In the various figures:

FIG. 1 shows a partial block diagram of an exemplary communications system for use in a ride-hailing service;

FIG. 2 shows a flow chart of a technique for searching for nearest neighbours;

FIG. 3 is a diagram of BFS for K-nearest search;

FIG. 4 shows a Naive K-nearest Search algorithm;

FIG. 5 shows an optimised K-nearest Search algorithm;

FIG. 6 shows the average number of visited cells in a visited shard.;

FIG. 7 shows comparisons of hashing vs ShardTable mapping;

FIG. 8 shows failure recovery results;

FIG. 9 is a table comparing calculations for different geospatial indices; and

FIG. 10 shows a highly simplified block diagram of an architecture of a distributed database.

### DETAILED DESCRIPTION

As used in this document, “database” is a structure with an operating and management system, the structure comprising memory, and the operating and management system being configured to store data into the memory in such a way as to facilitate search of data stored in the memory.

Where a database can be regarded as having plural logical rows each representing an object, and plural logical columns each representing an attribute of the objects, a “tuple” is a single row representing the set of attributes of a particular object.

“Hashing” is the transformation of a string of characters into a data item called a “key” that represents the original string. Hashing is used to index and retrieve items in a database because it is faster to find the item using the shorter hashed key than to find it using the original value.

“Consistent Hashing” is a distributed hashing scheme that operates independently of the number of nodes or objects in a distributed hash table by assigning them a position on an abstract circle, or hash ring. This allows nodes and objects to be added or removed without affecting the overall system.

“Sharding” refers to splitting a database up into unique data sets, allowing the data to be distributed to multiple servers, thereby to speed up searching of the data. Typically, a horizontal partition of a database. In the present context, the unique data sets each represent a respective geographically distinct area, each such area is termed a shard.

The term “shard” is also used herein to define the data content of each area, so that referring to shard x of data refers to the set of data for the geographical shard x A K-nearest neighbour search (kNN search) is a search that identifies the K nearest neighbours to the object under consideration.

A “redis” (Remote Dictionary Server) is a type of data-structure server useable as a database with very high read-write capability.

An “in-memory database” (IMDB) also referred to as a main memory database system or MMDB) is a database management system that primarily relies on main memory for computer data storage. Accessing data in-memory reduces or eliminates seek time when querying the data.

The term “replica sets” indicates separately stored instances of the same data.

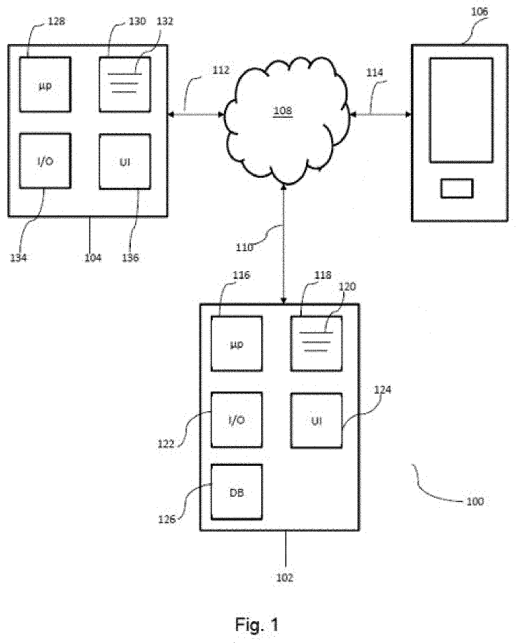

Referring first to FIG. 1, a communications system 100 for a ride hailing application is illustrated. Communications system 100 comprises communications server apparatus 102, service provider communications device 104, also referred to herein as a service provider device, and client communications device 106. These devices are connected in the communications network 108 (for example the Internet) through respective communications links 110, 112, 114 implementing, for example, internet communications protocols. Communications devices 104, 106 may be able to communicate through other communications networks, such as public switched telephone networks (PSTN networks), including mobile cellular communications networks, but these are omitted from FIG. 1 for the sake of clarity.

Communications server apparatus 102 may be a single server as illustrated schematically in FIG. 1, or have the functionality performed by the server apparatus 102 distributed across multiple server components. In the example of

FIG. 1, communications server apparatus 102 may comprise a number of individual components including, but not limited to, one or more processors 116, a memory 118 (e.g. a volatile memory such as a RAM) for the loading of executable instructions 120, the executable instructions defining the functionality the server apparatus 102 carries out under control of the processor 116. Communications server apparatus 102 also comprises an input/output module 122 allowing the server to communicate over the communications network 108. User interface 124 is provided for user control and may comprise, for example, conventional computing peripheral devices such as display monitors, computer keyboards and the like. Server apparatus 102 also comprises a database 126, one purpose of which is to store data as it is processed, and to make that data available as historical data in the future.

Service provider device 104 may comprise a number of individual components including, but not limited to, one or more microprocessors 128, a memory 130 (e.g. a volatile memory such as a RAM) for the loading of executable instructions 132, the executable instructions defining the functionality the Service provider device 104 carries out under control of the processor 128. Service provider device 104 also comprises an input/output module 134 allowing the Service provider device 104 to communicate over the communications network 108. User interface 136 is provided for user control. If the Service provider device 104 is, say, a smart phone or tablet device, the user interface 136 will have a touch panel display as is prevalent in many smart phone and other handheld devices. Alternatively, if the service provider communications device is, say, a conventional desktop or laptop computer, the user interface may have, for example, conventional computing peripheral devices such as display monitors, computer keyboards and the like.

Client communications device 106 may be, for example, a smart phone or tablet device with the same or a similar hardware architecture to that of service provider device 104.

In use, in an embodiment, the service provider device 104 is programmed to push packets of data to the communications server device 102, e.g. by sending an API call directly to the database. The packets contain information, for example information representing the ID of the service provider device 104, the location of the device, the time stamp and other data indicative of other aspects such as for example if the service provider is busy or idle.

In some embodiments, the pushed data is held in a queue to enable it to be accessed by the server 104 synchronously with the clock of the server. In other embodiments, the pushed data is accessed immediately.

In yet other embodiments, the service provider device 104 responds to information requests from the server 102, rather than pushing data to the server.

In yet other embodiments, data are obtained by pulling information from a stream of data emitted by the service provider device.

In embodiments where data is pushed from the service provider device, the transfer into the database of the embodiment may be performed using Kafka streams. Where no such means are employed and a small number of simultaneous data pushes occur, the database is configured to handle those concurrently. Where a large number of pushes occur, the incoming data is held in a message queue implemented as a FIFO memory.

The packetised data from the service provider device 104 is used by the server in a number of ways, for example for matching client requests to service providers, for managing the ride hailing system—for example for advising service providers where work is likely to be or to become available—and for storage as historical database 126.

Some of the packetized data is transformed into data tuples for storage by a database for performing kNN searches.

In an embodiment, a data tuple consists of four attributes (id, loc, ts, metadata) representing that the object identified uniquely by id is at location loc at timestamp ts. Metadata specifies the status of the object. For instance, a service provider's metadata may indicate whether the service provider is a car driver for ride-sharing or a motorcycle service provider for food delivery. A K-nearest search query is represented as (loc, ts, k) where loc is the location coordinate, and ts is the timestamp. Given a K-nearest query (loc, ts, k), the database of an embodiment returns up to k data tuples that are the closest to the query location loc. Note that this embodiment assumes straight line distance.

In one family of embodiments, the query timestamp ts is also retrieved to validate the timeliness of data tuples since the focus is on real-time locations within a short time period.

The database of the embodiment includes a decentralized data store where data are spread across different nodes for storage thereat. Data tuples of service providers located in one or more geographical shards are stored at respective nodes. In the current embodiment the data are not duplicated between nodes, and only a single instance is written. As far as possible, the embodiment writes data tuples representative of spatially close service providers together to enable rapid kNN searches. It will be noted however that where a first service provider of interest is at or close to a boundary of a shard stored at one node, there may be service providers close to the first service provider but actually located in a neighbouring shard whose data are stored at another node.

Determining where to store data is achieved by first partitioning data tuples into shards according to their geographical locations. A sharding algorithm then decides in which node a data shard resides.

As noted above, data tuples are partitioned into shards according to their geographical locations. In the present embodiment, this is achieved by partitioning the two-dimensional WSG (World Geodetic System) plane into grid cells (referred to herein as shards or geographical shards).

Latitude and longitude values range from −90 to +90, and −180 to +180, respectively. To simplify the problem, the grid size is defined to be as |x|, and thus there are in total

$$⌈ \frac{180}{l} ⌉ * ⌈ \frac{360}{l} ⌉$$

grid cells. A straightforward indexing function index (lat; lon) is used to calculate the grid id (i.e., shard id) of any given location (lat; lon):

$$shard\_id = index ( lat , lon ) = ( ⌊ \frac{l o n + 180}{l} ⌋ , ⌊ \frac{l a t + 90}{l} ⌋ )$$

Where (−180, −90) is the origin and the shard is the

$$⌊ \frac{lon + 180}{l} ⌋ th$$

cell on the origin's right and the

$$⌊ \frac{lat + 90}{l} ⌋ th$$

on the origin's top.

To accelerate K-nearest neighbour search, the embodiment maintains a two-level index hierarchy. By reducing the grid size I, geographical shards are partitioned further into smaller cells (referred to hereinafter as cells). To simplify the problem, in an embodiment the cell size is selected such that each cell belongs to exactly one shard. Each geographical shard contains a set of cells. Note that the physical size of shards may differ; shards near the equator will be physically larger than those near the poles. However, it may be assumed that nearby shards have similar physical sizes, especially where the focus of interest is in objects that are within a small radius (<10 km). In an embodiment, a geographical shard represents approximately a 20 km x 20 km square at the equator, while a cell represents approximately an area of 500 meters×500 meters.

A geographical shard is the smallest sharding unit. As noted above, data belonging to the same geographical shard are stored in the same node's memory. The embodiment distributes one or more geographical shards to a node based on a sharding function, i.e.

node_id=sharding(index(lat; lon)).

Details of the sharding algorithm are described later herein. Similarly, the sharding algorithm will map a cell to the node id where the cell is stored.

node_id=sharding(cell_id)

Given a database having plural nodes, each storing data on service providers in respective shards, the task is then to find the K nearest neighbours to any specific location, for example a location where a client requires a service to be provided, e.g. a pick-up location.

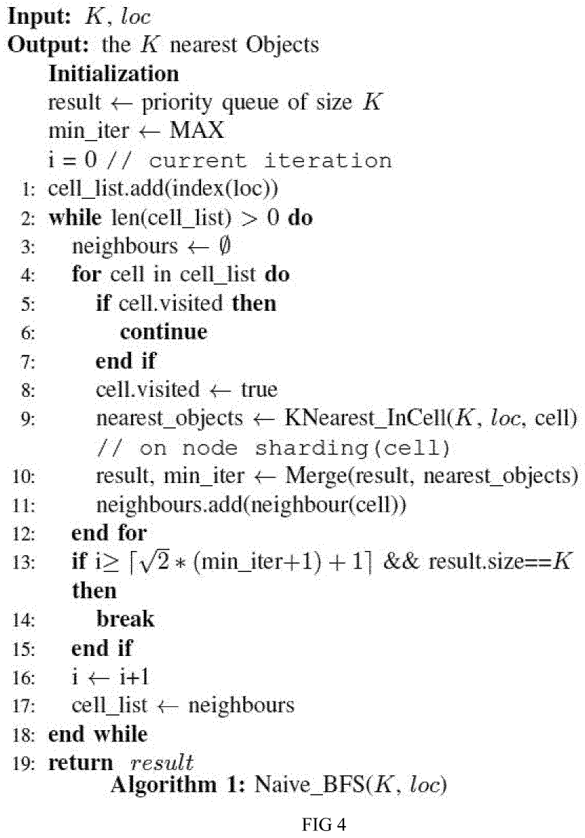

Naive K-nearest neighbour Search. Referring to FIG. 4 (Algorithm 1), given a location, an embodiment retrieves the K-nearest objects using breadth-first search (BFS).

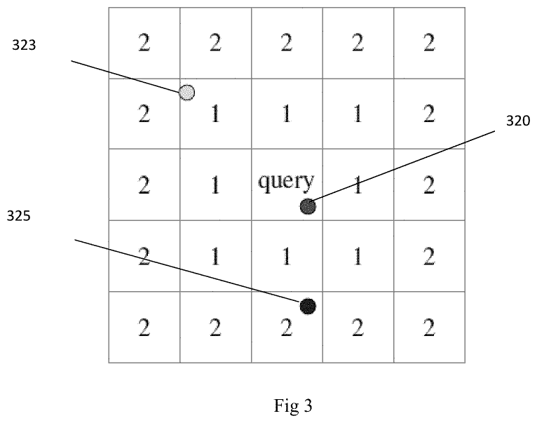

To start the cell to which the query location belongs is identified (Line 1), i.e., central dot 320 in FIG. 3. Then the search algorithm performs a breadth-first search on adjacent cells (Line 11). The numbers in FIG. 3 state the iteration number. When visiting a cell, the K-nearest objects within the cell are extracted by the algorithm, i.e., function KNearest InCell (Line 9). A global object priority queue of size K (result in the algorithm) is maintained based on the distance between the object and the given search location. Line 10 compares the K-nearest objects in the cell to merge to the final result.

Note that an object found in iteration i+1 (e.g. dot 323 in FIG. 3) may be closer than objects found in an earlier iteration i (e.g., dot 325).

Given the query cell where the query position lies in, the distance between any position in the cell and positions in cells found in iteration i ranges from (i−1)xl to √2x(i+1)xl where l is the length of a cell.

In this embodiment, Euclidean distance rather than haversine distance is used, without loss of generality. Therefore, the BFS terminates at the end of iteration i iff the K-nearest objects in result are found within iteration min_iter where

i=┌\sqrt{2}*(min_iter+1)+1┐

(Line 13). Note that min_iter is maintained by the merge function (Line 10).

The problem of the naive K-nearest search is that KNearest InCell (Line 9) is a remote call if sharding(cell) is not local. In the worst case, there will be O(n) remote calls where n is the number of cells visited. Note that cells belonging to the same shard are stored in the same node, which further results in multiple calls to the same node.

Next, the optimized K-nearest search algorithm (FIG. 5, Algorithm 2) to address the problem is described.

Recall that cells within a shard are stored together. Here the algorithm aggregates remote KNearest_InCell (K, loc, cell) calls together if they are within the same shard so as to reduce the number of remote calls to O (m) where m is the number of shards visited. In reality, the service is concerned only with the nearest objects within a radius r where r<< shard size. Therefore, the number m of shards visited is almost constant. The number of remote calls is thus reduced to O (1). In fact, given radius r, the total number of iterations needed in Algorithm 1 can be pre-computed to exit the loop early. Furthermore, it can also be verified whether a cell intersects with the circle radius r before visiting the cell.

Algorithm 2 presents the optimized K-nearest neighbour search. The algorithm first identifies the nearby crossing shards (Line 1), the details of which are omitted. Naïve_BFS (K, loc) is then run on the node locally where each shard is stored (Line 3). The algorithm then merges the results from all the shards (Line 4). Since shards are independent of each other, the remote calls are sent in parallel. Cells are also independent, within Naïve_BFS (K, loc), so KNearest InCell (K, loc, cell) is run in parallel as well.

When an object moves, an embodiment updates the location of the object. We store all the data tuples in-memory for fast updates. Recall that index(loc) uniquely identifies to which cell the new location belongs. If the object already exists in the cell, its location is simply updated. Otherwise, a new data tuple is inserted into the cell. The present embodiment does not deactivate the tuple's old location immediately. Data tuples have a TTL (Time To Live). When reading from or writing to a shard, the tuples in the shard whose TTLs have expired are deactivated. It thus can happen that a K-nearest query does not return a service provider's latest location. Nonetheless, tuples' timeliness is preserved by timestamps. The embodiment loosens the definition of K-nearest queries to return up to k data tuples that are the closest to the query location within a time period. This is sufficient in real-life applications.

The embodiment further releases useless data shards periodically. The data shards created in the daytime when most of drivers are active are released at night when drivers get off work.

Formally, a data shard is released from memory if all the drivers' locations in the shard are outdated (e.g., 10 mins ago). In practice, data shards are cleaned up every 15 minutes.

It can be postulated that a geospatial index would serve the partition purpose if the following conditions are satisfied:
Partition the earth into small chunks;
Uniquely map geographical coordinates to a chunk (a.k.a.a shard); and
Retrieve neighbouring chunks efficiently.

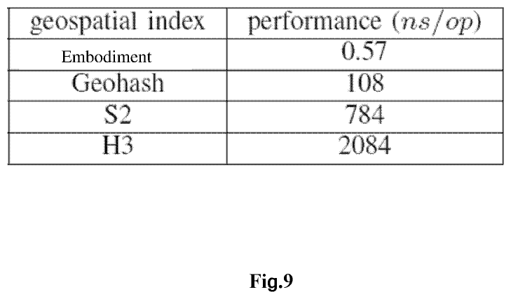

Recently developed geospatial indices such as S2 by Google, and H3 by Uber actually have the potential to accelerate the query phase. For instance, a hexagon in H3 has fewer neighbours than a square , which decreases the search space. However, the present embodiment's simple index can be calculated much faster (FIG. 9). Fast index calculation accelerates both write and read operations. Nonetheless, the present embodiment can be modular and the aforementioned indices can be plugged into the system if they are needed.

There follows a description of how the present embodiment manages nodes in the distributed setting to achieve low latency, high reliability and availability. A first proposition is ShardTable as a complement to consistent hashing to distribute data shards to nodes in order to achieve load balance. The well-known gossip protocol SWIM is then used for node discovery and failure detection. Finally, it is shown how an embodiment recovers from regional failures quickly.

Sharding Algorithm

This section describes how an embodiment distributes data shards to different nodes.

Consistent hashing is widely used for distributing an equal number of data shards to different nodes, with the benefit that a minimum amount of data needs to be moved when new nodes are added. However, this approach results in huge performance problems in practice because of unbalanced shard sizes and query needs. Certain shards contain much more objects than others. For instance, a shard in a bigger city (e.g., Singapore) has five times more drivers than a smaller city (e.g., Bali). Secondly, shards in high-demand areas (e.g., a downtown area) are queried much more often than rural areas. When distributing shards evenly to nodes, it is observed that certain nodes become hot spots with CPU usage exceeding 80% while some other nodes are idle.

Furthermore, adding new machines under consistent hashing may make things worse. For instance, in Amazon Web Services (AWS), scale-out is typically triggered by a high CPU usage of a node, i.e., a hot spot. When a new node is added, consistent hashing randomly chooses one or a few nodes and spares their data shards (and thus query load) to the new node. Unfortunately, the hot spot node is not guaranteed to be chosen, which results in the addition of new idle nodes while the hot spot is not mitigated at all.

An embodiment, therefore, trades off between data moving time and fast query time by using Shard Table. ShardTable is a user-configurable mapping from shards to nodes which explicitly defines which shard belongs to which node. In an embodiment a node is dedicated to each area of high-demand in a city. In some cases, a node can serve multiple small cities. For shards that are not in the shard table, the fall back is to use consistent hashing.

ShardTable is semi-automatic. When a hot spot node is observed, the present embodiment calculates the shards that need to be moved based on the read/write load on the shards. An administrator then moves the shards to an existing idle node or a new node.

The semi-automatic structure works well for the applicant. Human intervention is rarely needed when ShardTable is configured properly in the first place.

Node Discovery and Failure Recovery

An embodiment applies gossip style messaging for node discovery. Each node gossips around about its knowledge on the network topology. In particular, Serf is chosen because it implements SWIM with the Lifeguard enhancement. One problem with SWIM is that when a new node joins, a static coordinator is needed to handle the join request to avoid multiple member replies.

An embodiment subtly reuses one node in the ShardTable as the static coordinator to broadcast new joins. It is worth mentioning that SWIM provides time bounded completeness, i.e., the worst-case detection time of a failure of any member is bounded. To achieve that, SWIM applies Round-Robin Probe Target Selection. Each node maintains a current membership list, and selects ping targets in a round robin manner rather than randomly. New nodes are inserted into the list at random positions instead of being appended to the end to avoid being de-prioritised. The order of the list is shuffled every now and then after one traversal is finished. In addition, SWIM reduces false positives of failures by allowing members to suspect a node before declaring it as failed.

Note that using third-party node discovery services is deliberately avoided, to minimize service dependency as much as possible.

An embodiment takes a snapshot of the data periodically for failure recovery. The snapshot is stored in an external key-value data store Redis. In case of an outage where all the nodes power cycle and hence all the in-memory data are lost, an embodiment can start over by scanning the data snapshot in the Redis. Experiments demonstrate that an embodiment can recover from failures in one minute.

Replica Set and Query Forward

High reliability and durability require data duplication. An embodiment applies replica sets for data replication. Each data shard is replicated to multiple nodes where each node is treated equally. Write operations on a shard are propagated to all the replica nodes. Depending on consistency configuration, a quorum-based voting protocol may or may not be applied. If availability takes precedence over consistency, and because of location data's timeliness, consistency can be relaxed. The number of replicas is configurable based on use cases.

One embodiment prefers replica sets to a master-slave design. Maintaining master membership or re-electing a master incurs extra costs. In contrast, a replica set is more flexible. It trades consistency for availability. For shards distributed to nodes by consistent hashing, the classic implementation is used, namely storing its replicas on the next nodes in the ring. For a shard in ShardTable, the mapping maintains where the shard's replicas are stored.

When answering K-nearest neighbour queries, this embodiment treats each replica node equally. When a node receives a K-nearest neighbour search request on location, it invokes Algorithm 2.

With regard to remote calls (Line 3 in Algorithm 2), since there are replicas for each shard, there are two strategies to balance queries on replicas, fan-out or round-robin. In the fanout setting, the node sends remote calls to replicas in parallel and takes the result whichever is returned the fastest. In the round-robin setting, each replica takes remote calls in turn.

K-nearest Queries

In this section, there is compared the performance of the K-nearest neighbour query Algorithm 1 and Algorithm 2, using the applicant's real-life K-nearest neighbour queries. The applicant supports nearly 6 million rides daily, reaching a billion K-nearest neighbour queries per day. Recall that the time complexity of Algorithm 1 is dominated by the number of remote calls, which is linear in the number of cells visited. Algorithm 2 is linear in the number of shards visited. Therefore, the average number of visited cells in a visited shard is used to demonstrate the improvement of Algorithm 2 over Algorithm 1.

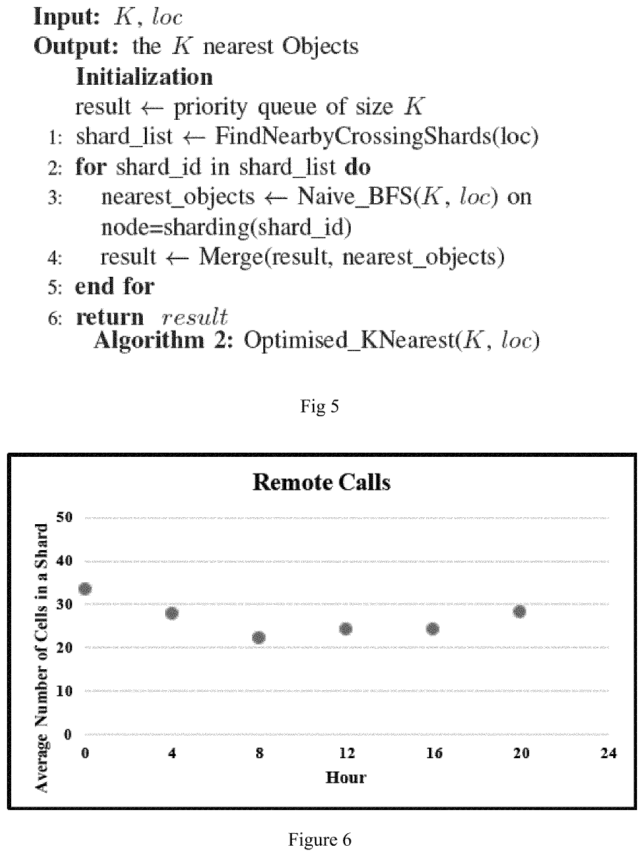

FIG. 6 shows the average number of visited cells in a visited shard. Note that as time changes (x-axis), the average number of visited cells in a visited shard varies slightly. On average, visiting a shard scans 27:3 cells, with the worst case of 120 cells. Algorithm 2 is therefore 27:3 times faster than Algorithm 1 on average. In addition, the average number of shards visited in Algorithm 2 is 1:27, which validates the constant time complexity.

Load Balancing

In this section, consistent hashing is compared against ShardTable in their load balancing performance. The experiments were run on 10 nodes. In one setting, consistent hashing is used for shard distribution, while in the other an embodiment is used with both ShardTable indexing and consistent hashing. Both write and K-nearest query loads are compared on a real-life environment. Some level of detail is not shown to present only secondary measures for commercial reasons.

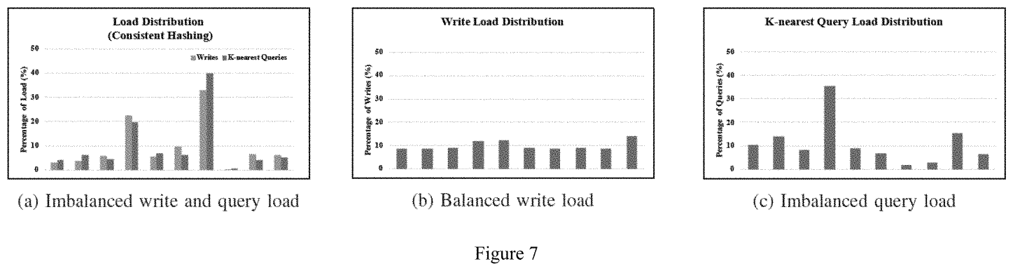

FIG. 7a presents the write and query load distribution on 10 nodes under consistent hashing. Recall that even though shards are equal in the physical world, certain countries have more drivers in one shard than the others and write operations are linear in the number of drivers. As FIG. 7a shows, the most extreme node hosts 32:9% of the overall drivers while another node takes the least 0:37% of the drivers. The sample variance is as high as 103. Similarly, the K-nearest neighbour query load is also imbalanced ranging from 0:72% to 39:84%.

FIG. 7b shows the write query load distribution among 10 nodes using the embodiment. It is clear that the write load is very well balanced, ranging from 8:71% to 13:92%. The sample variance is as low as 3:64. It is worth noting that currently An embodiment prefers balancing the write load over the K-nearest neighbour query load. FIG. 7c shows the embodiment's query load distribution. It can be seen that with a balanced write load, i.e., each node hosts almost the same number of drivers, the query load still varies, from 1:93% to 35:49%. However, it is better than consistent hashing.

Failure Recovery

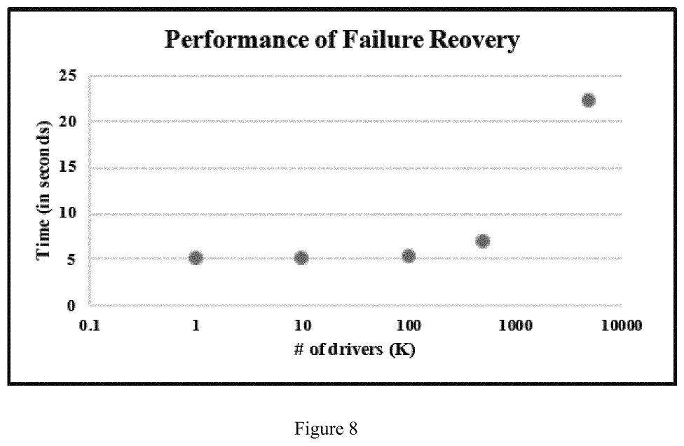

In this subsection, the performance of an embodiment is evaluated on failure recovery. The experiment was run on a Mac Pro with a 2.7 GHz Intel Core i7 and 16 GB memory. FIG. 8 shows the results.

The recovery time is evaluated as the number of drivers grows. As shown in FIG. 8 (note the logarithmic scale of the number of drivers), as the number of drivers grows from 1K to 5 million, the recovery time increases linearly. The embodiment can recover in less than 25 seconds, even with 5 million drivers.

Flowchart

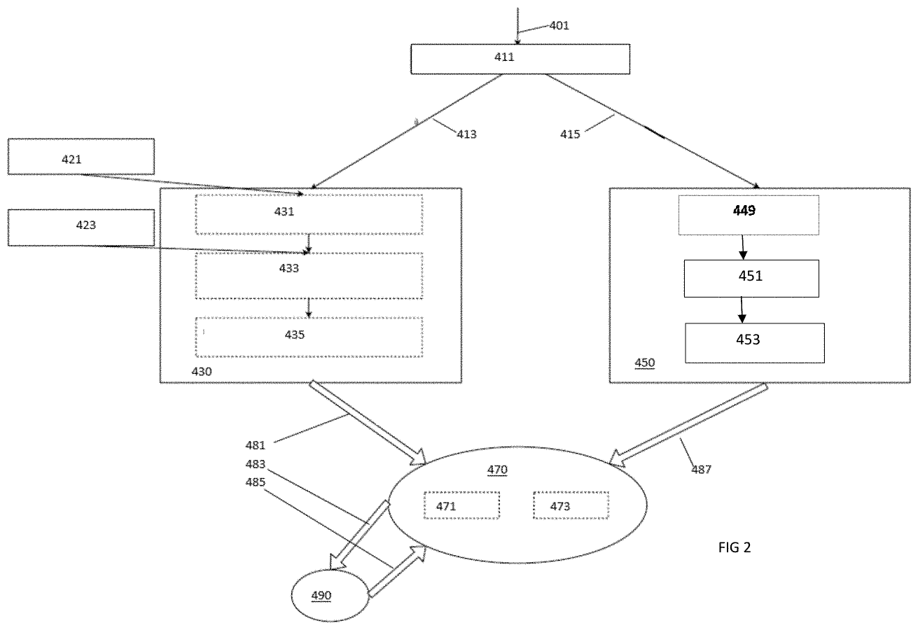

Referring to FIG. 2, a flow chart shows two processes 430 and 450 that are each running in inside plural nodes, whereas block 470 represents a plurality of replica sets. The data snapshot process 490 is running inside each node as well.

As shown, request and write data 401 are input to a load balancing device 411 which operates to distribute requests and writes among the different nodes, thereby to ensure even loading and the ability to handle a lot of reads and writes. The load balancing device 411 sorts data by type into writes of real-time location data 413, comprising write data tuples and K-nearest query requests 415.

Write data tuples include the geographical location of the objects under consideration e.g. vehicles in a ride hailing situation, the ID of each object, timestamp information and metadata, as described elsewhere herein.

K-nearest requests include data, for example in packets containing location data, timestamp, K, and radius of search.

The real-time location data 413 is passed to a storage unit 430, which performs two decisions. First decision unit 431 is supplied with data indicative of the partitioning the WSG plane into shards and calls from a geographical data source 421 to perform an index function whereby the decision is made as to which shard and cell the real-time location data 413 belongs.

Having made this decision, the real-time data are passed onto second decision unit 433, which is supplied with configuration data 423, data relevant to ShardTable and replica set size, so as to decide which node replica set the shard is located in.

The resultant data is then used by write unit 435 to insert the location of the object (vehicle, in the ride-hailing application) to the shard of the node replica set, or if already present on this shard to update the object location.

The storage unit writes this data 481 to distributed memory 470 to include node discovery 471 and data 473 of replica sets.

K-nearest request data 415 passes to a query unit 450 which runs a first process 449 to forward the request to the node hosting the primary shard data, second process, 451 for forwarding querying inside replica sets and then third process 453, that is running the distributed K-nearest query algorithm. The result is output as read data 487 to the distributed memory 470, and in this embodiment the result of the search algorithm is further returned (not shown on chart) to the caller who initiated the query in the first place. Search result is the ID of the K nearest drivers, plus their location data and timestamp.

The distributed memory 470 also writes a data snapshot 490, via write process 483, and this is useable for failure recovery 485.

Architecture

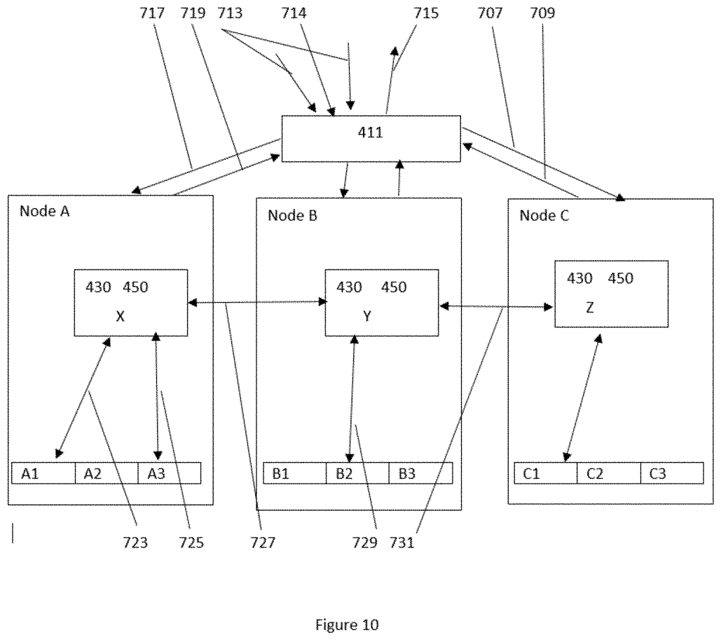

Referring to FIG. 10, a schematic block diagram of a simplified embodiment of an in-memory database system consists of 3 storage nodes, A, B and C, together with load balancing unit 411 described earlier herein with respect to FIG. 2. Each storage node A, B and C includes a respective processor X, Y, Z and a main memory, (e.g. RAM) A1, A2, A3. In use, the processors X, Y and Z perform the processes 430, 450 as described with respect to FIG. 2. In-memory (i.e. RAM) storage is used to support massive data write/update requests.

Although in future remote or in-Cloud storage might be envisaged it is not currently possible to handle the sort of write load that is required for a ride-hailing application.

It is important in embodiments to locate the storage nodes sufficiently close to one another that data transit time for a large amount of data flow does not become significant

Replica sets, which are plural peer sets, are stored on different nodes. One reason for this is that if one node fails, another node can still serve. The hashing/indexing process (consistent hashing or ShardTable indexing) is used to determine in which multiple nodes a particular shard is stored. In the embodiment, data are stored in plural nodes with no node being fixed as a primary home for that data.

In the following description and the accompanying drawing connections are shown as a single line for ease of explanation. It will be understood that this is unlikely to be the case in a real embodiment, in which extremely high data rates are transferred over multi-conductor buses or other interconnections.

As shown, the arrows 713 pointing towards balancing unit 411 represent service provider (e.g. driver location) update information being input to the system. Arrow 714 represents nearest neighbour search requests being input. Arrow 715 pointing upwards from unit 411 represent query results being output from the database. Load balancer 411 distributes search requests and service provider data among the nodes in order to balance the read and write loading. The arrows 717 from load balancing unit 411 to Node A represents service provider data being passed to a node (Node A), whereas arrows 719 represent query results leaving the node. 707 is data from unit 411 to Node C; 709 is query results from Node C.

At Node A, arrow 723 represents driver data flow to storage location Al from processor X and from storage location Al to processor X. Storage location A3 represents a replica set of the shard of data stored in location B2. Node B is the host node for the shard of data stored in location B2.

Arrow 725 represents read and write access to storage location A3, which it will be recalled stores a replica set of the data stored in location B2. As noted above, in an embodiment, replica sets are stored on different nodes, so that if one node has a problem there will still be service using another node or other nodes.

Arrow 727 represents data transfer between the processors X and Y of Nodes A and B, and arrow 729 represents data transfer to and from location B2. Arrow 731 represents data flow between processors Y and Z.

As a simplified example of operation, suppose a search is requested at load balancer 411 to search data stored in location B2, and this search request is passed by load balancer 411 over line 707 to Node C. After node C receives the request, it will use the consistent hashing or ShardTable index to “know” to forward the request to the ‘host’ node, Node B, via connection 731. where the query point is stored. The processor of the host node Node B will then run the query over line 729. When updating the data stored in location B2, the processor Y forwards update data over connection 727 so that replica set in location A3 is updated too.

The above represents a very simplified description of an unrealistic system. In practice there will be a plural replica sets resident on many nodes. The simple interconnection of node A to Node B to Node C will in many embodiments be replaced by a network of interconnections.

In use, if a search query is run in a fan-out mode, then both Node A and Node B will execute the query on the data and return. In this case, both A and B are host nodes. If the setting is round-robin, then for example Node A and Node B take turns to be host node to execute queries.

Advantages of Embodiments

Embodiments provide support for massively frequent writes by keys. Write operations are needed to update and track all objects' current locations. A driver can move 25 meters per second in developed countries like Singapore. It is therefore important to update drivers' locations every second, if not millisecond. Thus, traditional relational databases or geospatial databases that incur disk I/Os for write operations are too expensive to use. Embodiments store data in-memory in a distributed environment.

Even though all the objects can fit in one machine's memory, a single machine soon becomes overwhelmed by the massive number of writes and kNN queries, bearing in mind the number of drivers whose real-time locations are reported. To address this issue, embodiments distribute objects (e.g., drivers) to different nodes (i.e., machines) according to their geographical locations.

Support for kNN searches by geographical locations. Well-known key-value data stores such as Dynamo and Memcache store objects as keys and their locations as values. A kNN search then requires scanning all the keys and calculating pair-wise distances, the latency of which is not acceptable. Traditional kNN search algorithms rely on indices such as R-trees to accelerate queries. However, maintaining such complex indices while processing frequent writes is not feasible. Embodiments apply a breadth-first search algorithm to answer K-nearest neighbour queries. By dividing shards further into small cells, an embodiment avoids full shard scanning. It starts with the cell in which the query point lies, and gradually searches neighbouring cells. To reduce remote calls, embodiments aggregate calls at the shard level, which also achieves parallelism.

Support for imbalanced loads. Since geographical shards are of fixed physical size (e.g., 20 km×20 km), it is not surprising that certain shards have more data and queries than others. For instance, a shard in a bigger city (e.g., Singapore) may have five times more drivers than in a smaller city (e.g., Bali). As a consequence, the former shard has five times more writes than the latter. Shards in high-demand areas (e.g., a downtown area) are queried much more often than rural areas. Such imbalanced loads lead to extreme difficulties on scale-out policies. Consistent hashing is widely used for scale-out since it minimizes the amount of data that needs to be moved across nodes. However, when one node becomes a hot spot and a new node is added, consistent hashing will choose a random node and transfer part of its data to the new node. If unfortunately, the hot spot node is not chosen, its situation will not be mitigated at all. The situation is very likely to end up with a dead loop of adding new idle instances.

An embodiment proposes ShardTable as a complement to, and for use alongside, consistent hashing for load balancing. While consistent hashing distributes an approximately equal number of shards to nodes, ShardTable is configured to dedicate one or more nodes to one particular shard. ShardTable is a semi-automatic structure, though, in practice, human interventions are rarely needed.

Reliability, fast failure detection and recovery. Embodiments use replica sets to sacrifice strong consistency for high availability. At the same time different replicas may see different data statuses, which is not critical in our use case. Replica sets make the whole system highly available. Embodiments leverage the gossip-style protocol SWIM to achieve fast failure detection. In the case of a regional outage, embodiments can recover quickly from an external data store where data snapshots are kept asynchronously.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. A database system configured to search plural mobile objects, each object having attributes including location data, to determine neighbouring objects nearest to a specific location, said object being located in a geographical space made up of plural spatially distinct subspaces, each being made up of plural cells, the database system comprising plural storage nodes; and an operating system, the operating system being configured to control storage of object data amongst the plural nodes, wherein the operating system is configured to cause storage of data representative of one or more spatially distinct subspaces in a respective single one of the storage nodes, and wherein location data of each object is used to index that object with respect to cells making up each spatially distinct subspace in each node.

2. A database system according to claim 1, wherein the data of each spatially distinct subspace is stored completely in a single storage node.

3. A database system according to claim 1, wherein the operating system is configured such that data of each spatially distinct subspace is replicated to plural storage nodes to form data replicas.

4. A database system according to claim 3 wherein the operating system is configured such that write operations concerning a spatially distinct subspace are propagated to all the relevant data replicas.

5. A database system according to claim 3, wherein the number of replicas is configurable based on use cases.

6. A database system according to claim 1, wherein the operating system is configured to operate a breadth-first search algorithm to answer K-nearest neighbour queries

7. A database system according to claim 1, wherein data are stored in the plural storage nodes by consistent hashing.

8. A database system according to claim 1, wherein data are stored in the plural storage nodes using a user-configurable mapping from subspaces to storage nodes which explicitly defines which subspace belongs to which storage node.

9. A database system according to claim 1, wherein for load balancing, the operating system is configured to use both a user-configurable mapping from subspaces to storage nodes which explicitly defines which subspace belongs to which node, and consistent hashing.

10. A database system according to claim 9, wherein for data not included in the mapping, consistent hashing is employed.

11. A database system according to claim 8, in which one node in the mapping is used as a static coordinator to broadcast new joins.

12. A database system according to claim 1, wherein the operating system applies gossip style messaging for node discovery.

13. A database system for a ride hailing application according to claim 1, wherein the objects are service provider vehicles.

14. A database system according to claim 1, wherein the database is stored in-memory.

15. A method of storing data representing plural mobile objects, each object having attributes including location data, to enable fast searching for neighbours nearest to a specific location in a geographical space made up of plural spatially distinct subspaces, each being made up of plural cells, the database system comprising plural storage nodes; the method comprising:
storing object data amongst the plural storage nodes, such that data representative of one or more spatially distinct subspaces is stored in a respective single one of the storage nodes, and
using current location data of each object to index that object with respect to cells making up each spatially distinct subspace in each storage node.

16. A method of accelerating a nearest-neighbour search comprising distributing data in plural storage nodes according to the geographical relationship between the data, such that data representative of one or more spatially distinct subspaces is stored in a respective single one of the storage nodes and indexing the data with respect to location within cells making up each spatially distinct subspace thereby allowing a search of data to be performed using a reduced number of remote calls.

17. A scalable in-memory spatial data store for kNN searches comprising a database system as claimed in claim 1.
